(19) United States
(12) Patent Application Publication
(10) Pub. No.: US 2006/0205621 A1
(43) Pub. Date: Sep. 14, 2006

(54) Bacterial attachment reduction to biomaterials and biomedical devices

(75) Inventors: Roya Borazjani, Rochester, NY (US); Daniel M. Ammon JR., Rochester, NY (US); Joseph C. Salamone, Fairport, NY (US); Zhenze Hu, Pittsford, NY (US); Dharmendra M. Jani, Rochester, NY (US)

Correspondence Address: Bausch & Lomb Incorporated, One Bausch & Lomb Place, Rochester, NY, 14604-2701, US

(73) Assignee: Bausch & Lomb Incorporated, Rochester, NY (US)

(21) Appl. No.: 10/666,771

(22) Filed: Sep. 18, 2003

Related U.S. Application Data
(60) Provisional application No. 60/414,958, filed on Sep. 30, 2002.

(51) Int. Cl. C11D 3/20

(52) U.S. Cl. 510/161

(57) ABSTRACT

Compositions for inhibiting attachment of microorganisms to the surface of biomaterials include a polyether, such as a poloxamer. The compositions are especially useful for treating contact lenses to prevent bacterial attachment to the lens.

### FIELD OF THE INVENTION

The present invention relates to methods and compositions for inhibiting attachment of microorganisms to the surface of biomaterials including biomedical devices, such as contact lenses.

In general, the present invention is directed to a method of modifying the surface of a biomaterial or medical device formed therefrom to decrease surface affinity for bacterial adhesion. The present invention may comprise low ionic strength compositions for treating the biomaterial to reduce bacterial attachment.

The present invention comprises a method of treating a surface of a biomedical material or device with a composition comprising a polyether material containing hydrophobic and hydrophilic groups. The present invention further relates to a method for inhibiting adhesion of bacteria to a surface of a biomedical device in which the surface of the biomedical device is contacted with a polyether in an aqueous solution, which may have an ionic strength of from about 200 mOsom/kg to about 400 mOsom/kg.

### BACKGROUND

Bacterial attachment to biomaterial surfaces is believed to be a contributing factor in medical device-related infection. Examples of medical devices found to be susceptible to infection may include ophthalmic lenses, such as contact lenses or intraocular lenses, intraocular implants, membranes and other films, catheters, mouth guards, denture liners, tissue replacements, heart valves, etc. Despite many years of ongoing research and development of such devices, the extent to which different microorganisms will attach to a specific biomaterial or device remains difficult to predict.

As a result, those skilled in the art have recognized that chemical and physical properties of biomaterials may affect the ability of microorganisms to cause surface attachment and infection. Various approaches for inhibiting bacterial attachment in a wide variety of biomedical devices, which range from dental and medical implant or prosthetic devices to aqueous water bacterial treatment systems, are taught in U.S. Pat. No. 5,945,153 to Dearnaley; U.S. Pat. Nos. 5,961,958 and 5,980,868 to Homola et al.; U.S. Pat. No. 5,984,905 to Dearnaley; U.S. Pat. No. 6,001,823 to Hultgren et al.; U.S. Pat. No. 6,013,106 to Tweden et al.; and U.S. Pat. No. 6,054,054 to Robertson et al. Microbial attachment from conventional use of opthalmic products may result in infections due to microbial keratitis, such as caused by bacteria or acanthamoeba, or ulcerative keratitis. For example, when a contact lens is not cleaned sufficiently by a lens wearer, problems may result when bacterial load on a lens increases to the extent that a biofilm residue forms on that lens. In those cases where a biofilm has formed, not all lens cleaning solutions are strong enough to kill residual bacteria. Contact lenses may also retain infectious keratitis organisms, such as acanthamoeba, that can contaminate both lenses and contact lens cases. Such problems associated with contact lens wear may lead to other potential contact lens related complications, which include sterile infiltrates and contact lens induced acute red eye (CLARE). Thus, it would be desirable to develop a method for inhibiting attachment of microorganisms to biomaterials and biomedical devices, such as contact lenses, contact lens cases, etc. and corresponding compositions for use in such aforementioned methods.

In light of the foregoing, it has been recognized in the art that specific types of materials used in construction of or with such medical devices may afffect biocompatibility during conventional consumer use. For example, increasing hydrophilicity of a contact lens surface is known to improve wettability and wear comfort of contact lenses.

Medical devices are conventionally known to be prepared from two major classes of materials or biomaterials known as hydrogels and non-hydrogels. Hydrogels are defined as hydrated, cross-linked polymeric systems containing, absorbing and retaining water in an equilibrium state. Non-hydrogels are defined as materials that do not absorb appreciable amounts of water. In general physical properties of hydrogels vary widely, but are determined mostly by water content which range from about 10% water by weight to about 90% water by weight. Hydrogels have been found to exhibit excellent biocompatibility properties due to such properties.

Based upon such properties, hydrogels have been extensively used for various biomedical applications. Hydrogel materials may be used in the formation, preparation and manufacture of ophthalmic lenses, intraocular implants, membranes and other films, catheters, mouth guards, denture liners, tissue replacements, heart valves, intraocular implants, membranes and other films, diaphragms, catheters, mouth guards, denture liners, tissue replacements, heart valves, intrauterine devices, ureter prostheses, etc. Hydrogels have especially been useful for soft contact lenses.

Contact lenses in wide use fall into conventional categories: (1) hard lenses formed from materials prepared by polymerization of acrylic esters, such as polymethyl methacrylate (PMMA), (2) rigid gas permeable (RGP) lenses formed from silicone acrylates and fluorosilicone methacrylates, (3) soft, hydrogel lenses, and (4) non-hydrogel elastomer lenses. Hard and rigid-type lenses have a relatively low vapor diffusion and absorb only minor amounts of aqueous fluids, and have a lower tendency to bind ingredients used in contact-lens care solutions. In contrast, soft hydrogel lenses have a greater tendency to bind active ingredients in contact lens solutions, materials from tear film, and external contaminants.

Biocompatibility, surface property and high user comfort standard characteristics are important aspects considered in the design of conventional and extended wear contact lenses. During typical user wear, contact lens surfaces are susceptible to accumulation or adherence of proteinaceous and lipid material from tear fluid. Such accumulated deposition can cause eye discomfort or even inflammation. Proteinaceous materials may include: lysozyme, lactoferrin, albumin, mucoproteins, and all lachrymal tear constituents. As part of a routine care regimen, contact lenses worn repeatedly over an extended time period must be cleaned to remove these materials.

Extended wear lenses are continuously worn without daily removal or disinfection before sleep. A user typically wears extended-wear lenses in continuous contact with corneal epithelium until the end of a recommended 7 day to 30 day period. Such procedures are distinguishable from a daily wear care regimen in which lenses are removed from the eye before sleep and disinfected daily.

Different types of contact lens cleaning, proteinaceous deposit removing, disinfecting, preserving solutions, etc. are illustrated in the following patents.

U.S. Pat. No. 6,323,165 to Heiler teaches compositions and methods for blocking proteinaceous deposits on hydrophilic contact lenses. The aforementioned compositions contain polyquaternium polymers that selectively bind to lenses and block such deposits.

U.S. Pat. No. 4,168,112 to Ellis discloses contact-lens solutions applicable to rigid gas permeable (RGP) lenses, which contain cationic polymers that coat or form a hydrophilic polyelectrolytic complex on a lens surface. Ellis teaches an approach to solving the problem of protein deposits by trying to prevent proteins from adhering to a contact lens surface in the first place. Such a complex behaves as a hydrogel “cushion” thought to increase the wettability, hydrophilic character and comfort of the lens, while reducing a tendency for mucoproteins adherence to a lens surface. Ellis further teaches use of polyquaternium polymers and copolymers and immersion of a hard contact lens in a polyvinylbenzyl trimethyl ammonium chloride solution followed by a distilled water rinse.

U.S. Pat. No. 4,443,429 to Smith et al. discloses the use in a contact-lens disinfecting solution of a dimethyldiallylammonium chloride homopolymer commercially known as Merquat™ 100 (i.e., which has a molecular weight of about 10,000 to about 1,000,000. Preferred disinfecting solution concentrations were recited therein as 0.0004 weight percent to about 0.02 weight percent (4 ppm to 200 ppm).

U.S. Pat. No. 4,388,229 to Fu discloses a contact-lens solution for rejuvenating lenses by removing adsorbed and occluded chemical and biological agents, particularly antimicrobial agents adsorbed from a disinfecting solution. The patent discloses the use of strongly basic anionic exchange resins having quaternary-ammonium exchange groups. After the rejuvenation procedure, the lenses may be treated with water, a cleaning and preserving solution to remove any residual rejuvenation solution.

U.S. Pat. No. 5,096,607 and WO 94/13774, respectively, to Mowrey-McKee et al. disclose use of polyquaterniums as antimicrobial agents, typically in amounts less than 100 parts-per-million (ppm) in actual commercial practice.

In the area of contact lens wetting/conditioning solutions, it also has been found that hydrophilic-hydrophobic polyethers can adsorb to a lens surface. Such surface interactions, particularly with certain Pluoronic® of ethylene oxide-propylene oxide block co-polymers, have commercially been demonstrated to give more comfortable lens materials because of the greater adsorption of surface bound water. For example, U.S. Pat. No. 6,417,144 to Tsuzuki et al. discloses a contact lens solution, which is comprised of an amino acid type cationic surfactant and at least one nonionic surfactant, such as polyoxyethylene-polyoxypropylene block copolymer or corresponding derivatives.

Bacteria that attach to contact lenses and accumulate over time may lead to infection. Thus, an improved method for inhibiting bacterial attachment would be a major advance in the usage of conventional and extended wear contact lenses.

There remains a need for methods of inhibiting attachment of microorganisms, such as bacteria, to the surface of different types of medical devices made from different biomaterials and corresponding compositions of materials to be used in the aforementioned methods. There is a further need for the development of different types of chemical compositions for treating a biomaterial to reduce bacterial attachment. Such compositions may also be useful in treating manufactured biomaterials before such materials are fabricated or formed into the final or actual medical device products used.

The present invention is directed to overcoming the problems encountered in the art.

### SUMMARY OF THE INVENTION

The present invention relates to methods and compositions for use in inhibiting and/or treating attachment of microorganisms to the surface of biomaterials and biomedical devices.

In general, the present invention is directed to a method of modifying the surface of biomaterials and medical devices to decrease surface affinity for bacterial adhesion. The present invention may comprise low ionic strength compositions for treating a biomaterial to reduce bacterial attachment.

The present invention comprises a method treating a surface of a biomedical material or device with a composition, which comprises polyether material containing hydrophobic and hydrophilic groups.

The present invention further relates to a method for inhibiting adhesion of bacteria to a surface of a biomedical device in which the surface of the biomedical device is contacted with a polyether in an aqueous solution, which may have an ionic strength of from about 200 mOsom/kg to about 400 mOsom/kg.

The present invention also relates to a method for inhibiting adhesion of bacteria to the surface of a contact lens, which comprises applying to the surface of the contact lens a polyether to form a surface coating of the polyether on the surface of the contact lens.

### DETAILED DESCRIPTION OF THE INVENTION

The present invention relates to methods and corresponding compositions for inhibiting and/or treating attachment of microorganisms to the surface of biomaterials and biomedical devices.

In particular, the present invention relates to a method for inhibiting adhesion of bacteria to a surface of a biomedical device, which comprises the steps of:
[a]pre-treating the surface of the biomedical device with a chemical agent or solution to provide a reactive group on the surface; and
[b] contacting the reactive group on the surface with a polyether in an aqueous solution, such that wherein the reactive group forms a chemical binding interaction with the polyether in the aqueous solution.

The present invention also relates to a method for inhibiting adhesion of bacteria to the surface of a contact lens, which comprises applying to the surface of the contact lens a polyether to form a surface coating of the polyether on the surface of the contact lens.

Unless defined otherwise, all technical, scientific and nomenclature terms used herein are defined as conventionally used in the art.

The methods and compositions of the present invention may be applicable and use a wide variety of biomaterials and biomedical devices. Examples of relevant biomaterials and biomedical devices are set forth below.

In accordance with the present invention the term “biomedical device” means the a device formed from materials having physicochemical properties rendering them suitable for prolonged contact with living tissue, blood and mucous membranes. Biomedical devices suitable for use in the present invention, may include, but are not limited to ophthalmic lenses, intraocular implants, membranes and other films, catheters, mouth guards, denture liners, stents, tissue replacements, heart valves, etc. Examples of different types of opthalmic lenses suitable for use may include, but may not limited to intraocular lenses and contact lenses.

The present invention is directed also to methods for treating biomaterials before or after fabrication of a broad range of medical devices, which may include, but are not limited to, examples such as ophthalmic lenses, stents, implants and other devices previously described herein.

For example, the methods and compositions of the present invention may be applicable to the conventional contact lense conventional contact lens categories: (1) hard lenses formed from materials prepared by polymerization of acrylic esters, such as polymethyl methacrylate (PMMA), (2) rigid gas permeable (RGP) lenses formed from silicone acrylates and fluorosilicone methacrylates, (3) soft, hydrogel lenses, and (4) non-hydrogel elastomer lenses. The method of the invention is especially useful with extended wear contact lenses that are suitable for periods of continuous wear for about 7 to about 30 days.

Substrate or component materials suitable or adaptable for use in different aspects of the present invention, may also include, but are not limited to the formation, preparation, formulation, manufacture, etc. of different biomaterials, biomedical devices, compositions, etc. of the present invention.

Most contact lenses marketed today are made of a hydrogel. As mentioned, hydrogel materials are particularly susceptible to attachment and accumulation of bacteria. Soft hydrogel contact lenses are made of a hydrogel polymeric material, a hydrogel being defined as a cross-linked polymeric system containing water in an equilibrium state. In general, hydrogels exhibit excellent biocompatibility properties, i.e., the property of being biologically or biochemically compatible by not producing a toxic, injurious or immunological response in a living tissue. Representative conventional hydrogel contact lens materials are made by polymerizing a monomer mixture comprising at least one hydrophilic monomer, such as (meth)acrylic acid, 2-hydroxyethyl methacrylate (HEMA), glyceryl methacrylate, N,N-dimethacrylamide, and N-vinylpyrrolidone (NVP). In the case of silicone hydrogels, the monomer mixture from which the copolymer is prepared further includes a silicone-containing monomer, in addition to the hydrophilic monomer. Generally, the monomer mixture will include a crosslinking monomer, i.e., a monomer having at least two polymerizable radicals, such as ethylene glycol dimethacrylate, tetraethylene glycol dimethacrylate, and 2-ethylmethacrylate-vinylcarbonate. Alternately, either the silicone-containing monomer or the hydrophilic monomer may function as a crosslinking agent.

In one embodiment, the invention comprises a method of treating the surface of the biomedical material with compositions, such as polyether materials in aqueous solution, wherein such different polyethers may contain hydrophobic and hydrophilic groups and groups and are effective to inhibit attachment of bacteria and protein or lipid deposition to biomaterial surfaces, such as contact lens surfaces.

In another preferred embodiment, the present invention relates to a method for inhibiting adhesion of bacteria to the surface of a contact lens, which comprises applying to the surface of the contact lens a polyether to form a surface coating of the polyether on the surface of the contact lens.

Polyether materials and corresponding definitions suitable for use in the present invention are defined below as follows.

Polyethers suitable for use in the present invention may be derived from such block copolymers formed from different ratio components of ethylene oxide (EO) and propylene oxide (PO). Such polyethers and their respective component segments may include different attached hydrophobic and hydrophilic chemical functional group moieties and segments.

One specific class of such polyethers are poloxamers which are available under the tradename Pluronic. Poloxamers include Pluronics and reverse Pluronics. Pluronics are a series of ABA block copolymers composed of poly(ethylene oxide)-poly(propylene oxide)-poly(ethylene oxide) blocks. Reverse Pluronics are a series of BAB block copolymers, respectively composed of poly(propylene oxide)-poly(ethylene oxide)-poly(propylene oxide) blocks. The poly(ethylene oxide), PEO, blocks are hydrophilic, whereas the poly(propylene oxide), PPO, blocks are hydrophobic in nature. The poloxamers in each series have varying ratios of PEO and PPO which ultimately determines the hydrophilic-lipophilic balance (HLB) of the material.

Another specific class of polyethers is the poloxamines, available under the tradename Tetronic. These polyethers are contain blocks of PEO and PPO, which certain blocks connected by an ethylenediamine moiety.

Thus, preferred polyether materials may be exemplified by the commercially available block copolymers, which may include, but are not limited to poloxamers and poloxamines.

In accordance with the present invention, the mechanism for binding a polyether to the surface of the biomedical device is not critical, provided that the binding strength is sufficient to maintain the surface for the intended use of the biomaterial. Such binding of a polyether material may result in the formation of a surface coating of the polyether on the surface of a biomedical device, which may include a contact lens. For example, the coating of a polyether material, alone or in combination with other components suitable for use in the present invention, such as component materials defined herein, to and on the surface of a contact lens aids in inhibition or adhesion of bacteria to the surface of a contact lens.

As conventionally understood in the art, the term “binding” as applicable to the present invention may be defined to include: covalent bonds, hydrogen bonds, hydrophobic interactions or other chemical or molecular interactions. Such binding, chemical or molecular interactions may enable a polyether material, alone or in combination with other components suitable for use in the present invention, to form a stable or relatively strong surface coating on a biomedical device.

Also, with regard to polyether materials of the present invention, the terms “bond” and “bind” refer to chemical interactions between polyethers and biomaterials and biomedical devices, which may refer to, but may not be limited to, forming a chemically or relatively stable complex or other relatively stable chemical attraction between the surface of a biomedical device which may have attached reactive chemical functional group moieties and a polyether with or without the addition of a linking agent or which also may have attached reactive chemical functional group moieties, and is not limited to a particular mechanism.

The art has demonstrated polyether use in different compositions, such as in contact lens solutions, to inhibit protein or lipid deposition to biomaterial surfaces, proteinaceous deposit removing, disinfecting, preserving solutions, etc.

Significantly, use of polyethers in compositions to inhibit attachment of bacteria to such surfaces has not been demonstrated in the art before the present invention. The ether-containing polymers of the invention have been found to exhibit strong anti-attachment properties (activity) for the bacterium, Pseudomonas aeruginosa, Staphylococcus aureus, Serratia marcescens as shown in studies of attachment to contact lens surfaces. This effect was unexpected because bacterial cell walls are largely composed of polysaccharides, or polysaccharides that contain a small amount of short-chain amino acids such as bridging units between the polysaccharides.

In accordance with the present invention, typical mechanisms involve chemical binding interactions between a surface of the biomedical device and a polyether as previously discussed, may include, but are not limited to ionic chemical interactions, covalent interactions, hydrogen-bond interactions, hydrophobic interactions, and hydrophilic interactions. For example, polyether materials used in the present invention may attach to the surface of the biomaterial through various chemical or molecular interactions between hydrophobic sites on the biomaterial surface interacting with hydrophobic groups on the polyether.

Covalent linkages or interactions in association with chemical materials, such as polymeric materials, of the present invention, may exist between the biomaterials surface and the water-soluble polyethers such that the polyethers are bound to the biomaterial surface. Examples of covalent linkages include those provided by coupling agents, such as ester linkages and amide linkages.

The polyether may also bind to the surface of the biomedical device through hydrogen-bonding interactions. These hydrogen-bonding interactions, may involve hydrogen-bond donating groups or hydrogen bond accepting groups located on the surface of a biomedical device or as a chemical functional group moiety attached to a polyether material. Such hydrogen-bond donating groups or hydrogen bond accepting groups are defined herein.

Hydrophobic interactions occur through hydrophobic sites on the biomaterial surface interacting with hydrophobic groups on the polyether.

One embodiment of the present invention relates to a method for inhibiting adhesion of bacteria to a surface of a biomedical device, which comprises the steps of pre-treating the surface of the biomedical device with a chemical agent, composition or solution to provide a reactive group on the surface; and contacting the reactive group on the surface with a polyether in an aqueous solution, such that wherein the reactive group forms a chemical binding interaction, such as those defined above, with the polyether in the aqueous solution.

Examples of suitable reactive or linking groups located on the surface of polyether materials of the present invention, may include, but are not limited to, those reactive groups formed during polymer formation or reactive groups formed or generated from a chemical reaction between chemical agents, compositions or solutions and the surface of a biomedical device via a pretreatment of step existing polymeric surfaces.

Examples of such polymeric reactive or linking groups, may include, but are not limited to hydrogen-bond donating surface groups, such as carboxylic acids, sulfuric acids, sulfonic acids, sulfinic acids, phosphoric acids, phosphonic acids, phosphinic acids, phenolic acid groups, hydroxy groups, amino groups, imino groups and the like. These hydrogen-bonding interactions include may occur between hydrogen-bond donating surface groups and chemical functional group moieties on the polyether, such as ether linkages attached to the polyether. Hydrogen-bond accepting groups are selected from the group consisting of pyrrolidone groups, N,N-disubstituted acrylamide groups and polyether groups. Additional examples of linking agents or chemical linkages, may include, but are not limited to those provided by conventional chemical coupling agents, such as ester linkages and amide linkages.

Surface linkages between different functional group moieties of materials use in the present invention (i.e., e.g., as attached either to a polyether material or a surface of a biomaterial or a biomedical device formed from a biomaterial) may also include surface complexations. Examples of such surface complexations may include, but are not limited to reaction products formed by treating a biomaterial comprising a hydrophilic monomer and a silicone-containing monomer with a proton-donating wetting agent, where the wetting agent forms a complex with hydrophilic monomer on the surface of the biomaterial in the absence of a surface oxidation treatment step.

Also applicable for use in the present invention are other non-silicone hydrogels conventionally used for extended wear applications, provided that surface attachment of polyethers materials as described herein can be achieved.

The present invention may also be useful as a component of a cleaning, disinfecting or conditioning solution and composition containing such materials. Thus, examples of material components that may be suitable and adapted for use, which are dependent upon characteristics needed for a particular application of the present invention are described below.

The compositions employed in the present invention may contain, in addition to the polyethers described above, one or more other components that are commonly present in contact lens treatment solutions, for example, antimicrobial agents; tonicity adjusting agents; buffering agents; chelating agents; pH adjusting agents, viscosity modifying agents, and demulcents and the like, which aid in making ophthalmic compositions more comfortable to the user and/or more effective for their intended use.

Compositions for treating a contact lens will generally include an antimicrobial agent. Antimicrobial agents suitable for use in the present invention include chemicals that derive their antimicrobial activity through a chemical or physiochemical interaction with the microbial organisms. These agents may be used alone or in combination.

A particularly preferred antimicrobial agent is sorbic acid (0.15%). Other known antimicrobial agents include known organic nitrogen-containing agents such as biguanides. The biguanides include the free bases or salts of alexidine, chlorhexidine, hexamethylene biguanides and their polymers, and/or combinations of the foregoing. The biguanide salts are typically gluconates, nitrates, acetates, phosphates, sulfates, halides and the like. A preferred biguanide is the hexamethylene biguanide commercially available from Zeneca, Wilmington, Del. under the trademark Cosmocil™ CQ. Generally, the hexamethylene biguanide polymers, also referred to as polyhexamethylene biguanide (PHMB) or polyaminopropyl biguanide (PAPB), have molecular weights of up to about 100,000. Yet another example of a known primary antimicrobial agent is various materials available as polyquaternium-1.

The amount of the antimicrobial agent may vary depending on the specific agent employed. For the aforementioned organic nitrogen-containing agent, typically, such agents are present in concentrations ranging from about 0.00001 to about 0.5% weight percent, and more preferably, from about 0.00003% to about 0.05% weight percent. For sorbic acid, higher amounts may be required, typically 0.01 to 1 weight percent, more preferably 0.1 to 0.5 weight percent. It is preferred that the antimicrobial agent is used in an amount that will at least partially reduce the microorganism population in the formulations employed. If desired, the antimicrobial agent may be employed in a disinfecting amount, which will reduce the microbial bioburden by at least two log orders in four hours and more preferably by one log order in one hour. Most preferably, a disinfecting amount is an amount which will eliminate the microbial burden on a contact lens when used in regimen for the recommended soaking time (FDA Chemical Disinfection Efficacy Test—July, 1985 Contact Lens Solution Draft Guidelines).

The inclusion of an antimicrobial agent is not required to achieve the inhibition of bacterial attachment, but the antimicrobial agent is useful for at least partially reducing the microorganisms present on a contact lens, and, as mentioned, preferably this agent is used a disinfecting amount that which will reduce the microbial bioburden by two log orders in four hours and more preferably by at least one log order in one hour.

The aqueous contact lens solutions of the present invention are typically adjusted with tonicity agents to approximate the tonicity of normal lachrymal fluids (approximately equivalent to a 0.9% solution of sodium chloride or 2.8% glycerol solution). The solutions are made substantially isotonic with physiological saline used alone or in combination with other adjusting agents. The ophthalmic compositions preferably have an osmolality of about 225 mOsm/kg to 400 mOsm/kg, more preferably 280 mOsm/kg to 320 mOsm/kg.

The compositions may include chelating or sequestering agents in order to chelate or bind metal ions, which might otherwise react with the lens and/or protein deposits and collect on the lens. Examples of such preferred materials, may include, but are not limited to ethylene-diaminetetraacetic acid (EDTA) and its salts (disodium), which are usually added in amounts ranging from about 0.01 weight percent to about 0.2 weight percent.

The pH of the solutions and/or compositions of the present invention may be maintained within the range of pH=5.0 to 8.0, preferably about pH=6.0 to 8.0, more preferably about pH=6.5 to 7.8, most preferably pH values of greater than or equal to 7; suitable buffers may be added, such as borate, citrate, bicarbonate, tris(hydroxymethyl)aminomethane (TRIS-Base) and various mixed phosphate buffers (which may include combinations of Na₂HPO₄, NaH₂PO₄ and KH₂PO₄) and mixtures thereof. Borate buffers are preferred when the primary antimicrobial agent is PAPB. Generally, buffers will be used in amounts ranging from about 0.05 percent by weight to 2.5 percent by weight, and preferably, from 0.1 percent by weight to 1.5 percent weight.

The compositions of this invention may be useful as a component of a cleaning, disinfecting or conditioning solution and/or composition. Such solutions and/or compositions also may include, antimicrobial agents, surfactants, toxicity adjusting agents, buffers and the like that are known to be used components of conditioning and/or cleaning solutions for contact lenses. Examples of suitable formulations for cleaning and/or disinfecting solutions are taught in U.S. Pat. No. 5,858,937 to Richard et al., which is incorporated by reference as if set forth at length herein. Preferably, compositions and/or solutions of the present invention may be formulated as a “multi-purpose solution,” meaning that such compositions and/or solutions may be used for cleaning, chemical disinfection, storing, and rinsing a contact lens. A multi-purpose solution preferably has a viscosity of less than 75 cps, preferably 1 to 50 cps, and most preferably 1 to 25 cps and is preferably is at least 95 percent weight by volume water in the total composition.

A surfactant may be employed in the compositions to facilitate removal of protein and lipid deposits on the contact lens, as well as external contaminants. Surfactants, which are suitable for use in the present invention, are classified into cationic surfactants, anionic surfactants, nonionic surfactants and ampholytic surfactants depending upon their dissociation state in their aqueous solutions. Among them, various surfactants which are classified into cationic surfactants, particularly surfactants which consist of an amino acid derivative, i.e. amino acid type cationic surfactants, have conventionally been proposed as disinfectant cleaning agents or compositions for disinfection. Glycerin may also be included as a component of the present invention. Amphoteric surfactants suitable for use in a composition according to the present invention include materials of the type are offered commercially under the trade name “Miranol.” Another useful class of amphoteric surfactants is exemplified by cocoamidopropyl betaine, commercially available from various sources.

Various other surfactants suitable for use in the composition can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Optionally, one or more additional polymeric or non-polymeric demulcents may be combined with the above-named ingredients. Demulcents are known to provide wetting, moisturizing and/or lubricating effects, resulting in increased comfort. Polymeric demulcents can also act as a water-soluble viscosity builder. Included among the water-soluble viscosity builders are the non-ionic cellulosic polymers like methyl cellulose, hydroxyethyl cellulose, hydroxypropyl cellulose, and carboxymethyl cellulose, poly(N-vinylpyrrolidone), poly(vinylalcohol) and the like. Such viscosity builders or demulcents may be employed in a total amount ranging from about 0.01 to about 5.0 weight percent or less. Suitably, the viscosity of the final formulation is 10 cps to 50 cps. Comfort agents such as glycerin or propylene glycol can also be added.

The compositions of this invention can be prepared by a variety of techniques conventionally used in the art. One method involves a two-phase compounding procedures. In the first phase, about 30 percent of the distilled water is used to dissolve the polymeric components (such as the cationic cellulosic polymer) with mixing for about 30 minutes at around 50° C. The first-phase solution is then autoclaved at about 120° C. for 30 minutes. In a second phase, other components, such as alkali metal chlorides, sequestering agents, preservatives and buffering agents, are then dissolved in about 60 percent of the distilled water with agitation, followed by adding the balance of distilled water. The second-phase solution can then be sterilely added into the first-phase solution by forcing it through an 0.22 micron filter by means of pressure, followed by packaging in sterilized plastic containers.

Compositions, such as aqueous solutions, for use in the present invention, may be formulated as lens conditioning solutions or eye-drops and sold in a wide range of small-volume containers from 1 ml to 30 ml in size. Such containers can be made from HDPE (high density polyethylene), LDPE (low density polyethylene), polypropylene, poly(ethylene terepthalate) and the like. For eye drops, flexible bottles having conventional dispensing tops are especially suitable for use with the present invention. The eye-drop formulation of the invention is used by instilling, for example, about one (1) or three (3) drops in the eye(s) as needed.

In yet another aspect of the invention, accumulation of protein deposits on hydrophilic lenses is prevented or inhibited by wearing contact lenses conditioned by immersing those lenses in a solution that includes, in addition to the polyether, a polyquaternium polymer, especially the cationic polysaccharides disclosed in WO 02/34308. The presence of a polyether material of the present invention in a solution, which may include polyquaternium polymers and other suitable components, would be absorbed onto a contact lens while in-the-eye and inhibit uptake and accumulation of proteinaceous material and other ionic debris onto the contact lens. A contact lens solution containing such components may also be applied in the form of droplets while a contact lens is in the eye.

In general, polyquaternium polymers suitable for use in the present invention are a well known class of polymers of which many variations are commercially available. The polyquaternium polymer, preferably includes, an ophthalmologically suitable anionic organic or inorganic counterion. A preferred counterion may include, but are not limited to fluoride ions, chloride ions, bromide ions and the like.

For example, a current CTFA International Cosmetic Ingredient Dictionary includes polyquaterniums designated Polyquaternium-1 through Polyquaternium-44 a number of which, based on the present teachings, are useful in the present invention. The polymerization techniques for the preparation of such materials are similarly well known to those skilled in the art and many variations of such techniques are similarly in practice in commerce.

New variations of such polyquaternium polymers are in continuous commercial development, for example, various polymers having different combinations of the same or similar repeat units, different relative proportions of co-monomers, and different molecular weights are in continuous commercial development.

In particular, the polyquaternium polymers suitable for use in the present invention have a weight average molecular weight of about 5,000 to 5,000,000, preferably about 10,000 to 500,000, most preferably about 20,000 to 200,000.

The term “quaternary-amine-functional repeat unit” as used in the present invention, may be defined as a repeat unit, which may comprise a quaternary-amine group, in which a positively charged nitrogen atom is covalently bonded to four radicals (no hydrogen atoms) and ionically bonded to a negatively charged counterion such as chloride.

The term “moderately charged polyquaternium polymer” as used in the present invention, may indicate that a polymer comprise not more than about 45 mole percent net quaternary-amine-functional repeat units, wherein the mole percent net quaternary-amine-functional repeat units are the mole percent of quaternary-amine-functional (positively charged) repeat units minus the mole percent of anionic (negatively charged) repeat units in the polymer.

Suitable quaternary-amine-functional repeat units also include those found in polymeric ionenes and the like formed by a polycondensation reaction; in such repeat units, the nitrogens of the quaternary-amines are integral to the polymeric backbone and are situated between alkylene, oxyalkylene, or other segments.

Quaternary-amine-functional repeat units can also be obtained as a reaction product or two or more compounds, as for example, by the use of a strong alkylating agent such as 1,4-dichloro-2-butene which, for example, can be reacted with 1,4-bis[dimethylaminol]-2-butene and triethanolamine to produce a polymeric polyquartenary ammonium compound. Quaternary-amine-functional repeat units can also be made from other polymers, such as by the reaction of a trimethyl ammonium substituted epoxide with the hydroxy group of a hydroxyethylcellulose.

Preferably, the mole percent net polyquaternium repeat units is between about 10% and 45%, more preferably between about 20% and 40%, most preferably between about 25% and 35%. For example, if the polymer comprises 50 mole percent of a quaternary-amine-functional repeat unit derived from dimethyldiallyl ammonium chloride, 25 mole percent of an anionic repeat unit derived from carboxylic acid, and 25% of a neutral repeat unit derived from methyl methacrylate (or an substantially neutral repeat unit derived from hydroxyethyl methacrylate), then the mole percent net quaternary-amine-functional repeat units would be 25% (50% quaternary-amine-functional repeat units minus 25% anionic repeat units).

The nitrogens in the quaternary-amine-functional repeat units may be part of a saturated or unsaturated heterocyclic ring, most preferably a five- or six-membered ring. Most preferably, the polyquaternium polymer is a copolymer of a vinylimidazolium salt or a dimethyldiallyl ammonium salt. Up to 90%, preferably 40% to 90% by mole, of copolymerization-compatible comonomers not having a quaternary-amine-functionality may be copolymerized with the quaternary-amine-functional comonomers. Suitable comonomers include, but are not limited to, vinylpyrrolidone, acrylic acid, alkyl methacryate, amides and amines such as acrylamide and N,N-dialkylaminoalkyl acrylate and methacrylate, hydroxyethylcellulose and copolymerization-compatible mixtures thereof. A preferred alkyl group has 1 to 6 carbon atoms. Most preferably, alkyl groups are methyl, ethyl, and butyl.

Specific polyquaternium polymers useful in the present invention may include, but are not limited to, copolymers in which the quaternary-amine-functional repeat units are derived from one or more of the following kinds of monomers: N,N-dimethyl-N-ethyl-aminoethyl acrylate and methacrylate, 2-methacryloxyethyltrimethylammonium, N-(3-methacrylamidopropyl)-N,N,N-trimethylammonium, 1-vinyl and 3-methyl-1-vinylimidazole, N-(3-acrylamido-3-methylbutyl)-N,N,N-trimethylammonium, N-(3-methacryloyloxy-2-hydroxypropyl)-N,N,N-trimethylammonium, diallyldimethylammonium, diallyldiethylammonium, vinylbenzyltrimethylammonium, their halides or other salt forms, and derivatives thereof, for example, involving the substitution, addition, or removal of alkyl groups, preferably having 1 to 6 carbon atoms.

A specific example of a polyquaternium copolymer is Luviquate™ FC 370 polymer (CTFA International Cosmetic Ingredient Dictionary designation polyquaternium-16 commercially available from BASF, Ludwigshafen, Germany) which is the polymerization product of a mixture of comonomers of which 70% is vinylpyrrolidone and 30% is vinylimidazolium methylchloride, commercially available as a composition with a solids content of about 40% by weight in water. The polyquaternium copolymer is suitably present in an amount of 0.01 to 5.0 percent by weight in aqueous solution, preferably between 0.01 (100 ppm) and 1.0 percent by weight, most preferably between 200 ppm and 600 ppm. The contact-lens solution comprises 85 to 99% by weight, preferably 93 to 99% by weight, water.

Typically, the polyquaternium polymer used in a solution according to the present invention does not increase the hydrophilic character of a lens, which means that there is no increase in the water content of the lens following treatment with the solution. The water content of a lens can be determined based on a measurement of its refractive index.

In another aspect of the present invention, selected polyquaternium polymers simultaneously satisfy the dual requirements of both (i) meeting ophthalmological safety standards for an in-the-eye contact-lens solution at concentrations of 1000 ppm and (ii) inhibiting protein binding to a contact lens. The safety requirements can be determined according to the so-called NRDR (neutral red dye release) assay for cytotoxicity described in the Examples. In particular, the polyquaternium polymer should have an NRDR assay rating of L or less at a level of 1000 ppm., preferably L or less at a level of 500 ppm (dry weight of polymer, correcting for water content of the available polymer material). The requirement for exhibiting protein-binding inhibition can be determined, at least as an initial criterion, using a test carried out as described in the Example to obtain what is herein referred to as the “SPE protein-binding inhibition.” This test utilizes a particular type of Sep-Pak™ solid-phase extraction cartridge identified as the Accell Plus™ CM cartridge, Part #WAT020855, commercially available from Waters Corp., Milford, Mass. The material in this extraction cartridge is a weak cation exchanger that contains a silica support coated with a polymer having carboxymethyl groups. This extraction cartridge is first treated with a 1.0% solution of the polyquaternium polymer in borate-buffered saline followed by exposing the solid phase extraction cartridge to 0.05% lysozyme. The amount of protein-binding inhibition is determined compared to a control solution. In one embodiment of the invention, a suitable polyquaternium polymer exhibits at least 10% SPE protein-binding inhibition. Preferably, the SPE protein-binding inhibition is at least about 20%, more preferably at least about 30%, most preferably at least about 35%.

In general, the polyquaternium polymers suitable for use in the present invention have a weight average molecular weight of about 5,000 to 5,000,000, preferably about 10,000 to 500,000, most preferably about 20,000 to 200,000.

As mentioned, one preferred class of cationic materials is cationic polysaccharides, and especially, cationic cellulose derivatives. Specific examples include cellulosic polymers containing N,N-dimethylaminoethyl groups (either protonated or quaternized) and cellulosic polymers containing N,N-dimethylamino-2-hydroxylpropyl groups (either protonated or quaternized). Cationic cellulosic polymers are commercially available or can be prepared by methods known in the art. As an example, quaternary nitrogen-containing ethoxylated glucosides can be prepared by reacting hydroxyethyl cellulose with a trimethylammonium-substituted epoxide.

Various preferred cationic cellulosic polymers are commercially available, for example water-soluble polymers available under the CTFA (Cosmetic, Toiletry, and Fragrance Association) designation Polyquaternium-10. Such polymers are commercially available under the tradename UCARE® Polymer from Amerchol Corp., Edison, N.J., USA. These polymers contain quaternized NN-dimethylamino groups along the cellulosic polymer chain. Suitable cationic cellulosic materials have the following formula:

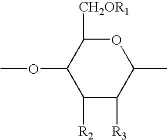

wherein R₁ R₂ and R₃ are selected from H, derivatives of C₁-C₂₀ carboxylic acid, C₁-C₂₀ alkyl groups, C₁ to C₃ monohydric and dihydric alkanols, hydroxyethyl groups, hydroxypropyl groups, ethylene oxide groups, propylene oxide groups, phenyl groups, “Z” groups and combinations thereof. At least one of R₁ R₂ and R₃ is a Z group.

The nature of the “Z” groups is:

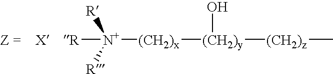

wherein:
R′, R″ and R′″ can be H, CH₃, C₂H₅, CH₂CH₂OH and CH₂CH(OH)CH₂OH
x=0-5, y=0-4, and z=0-5
X=Cl⁻, Br⁻, I⁻, HSO₄—, CHSO₄⁻, H₂PO₄⁻NO₃⁻

Various commercially available grades of the UCARE® polyquaternium-10 are summarized below:

| | JR-125 | JR-400 | JR-30 M |
|---|---|---|---|
| Brookfield Viscosity At | 110-120 | 400-440 | 12,000-13,000 |
| 25.degree.C., | 1.7-2.2 | 1.7-2.2 | 1.7-2.2 |
| centipoises, 2.0% by | | | |
| weight aqueous solution | | | |
| percent nitrogen | | | |

It is believed that the degree of inhibition activity is related to the strength of the ionic bonding between the polymeric surface coating and the lens surface. Thus, independent of the mechanism, stronger bonds are believed to be associated with a greater degree of resistance to bacterial adhesion.

### EXAMPLES

### Example 1

This example illustrates the binding effect of the polyether onto hydrophilic contact lenses so to reduce attachment of bacteria to the contact lens surface.

Treatment of Contact Lenses

Twenty-ml aliquots of polyether-containing solutions were poured into sterile polystyrene disposable petri dishes. Group III extended wear contact lenses (Purevision™, Bausch & Lomb Incorporated, made of a silicone hydrogel material and having an anionic charge) were removed from their packages with a sterile forceps and immersed five times in 180 ml of initially sterile 0.9% saline. These lenses were then placed into the petri dishes containing polyether-containing solutions and soaked for 4 hours at room temperature. After the 4 hour incubation time, the lenses were removed from the polyether-containing solutions with a sterile forceps and immersed 5 respective times in each of three successive changes (180 ml) of initially sterile 0.9% saline. The lenses were then transferred to 20 ml glass scintillation vials containing 3 ml of approximately 10⁸ cells/ml inoculum of radiolabeled cells, which were subsequently incubated at 37° C. for an additional 2 hours.

The various polyether-containing treatment solutions are listed in Table 1. These treatment solutions included a poloxamer, a poloxamine, a polyethylene glycol (PEG) and a polyethylene oxide (PEO). Additionally, control lenses were treated as above with phosphate buffered saline (PBS) containing no polyether.

Adherence Studies

Adherence studies were conducted on the aforementioned contact lens samples treated with the polyether-containing solutions, based on a modification of the procedures of Sawant et al. (Sawant, A. D., M. Gabriel, M. S. Mayo, and D. G. Ahearn (1991) Radioopacity additives in silicone stent materials reduce in vitro bacterial adherence, Curr. Microbiol. 22:285-292), and Gabriel et al. (Gabriel, M. M., A. D. Sawant, R. B. Simmons, and D. G. Ahearn (1995) Effects of sliver on adherence of bacteria to urinary catheter: in vitro studies, Curr. Microbio. 30:17-22), the disclosures of which are incorporated herein by reference.

Bacterial cells were grown in Triptic Soy Broth (TSB) at 37° C. on a rotary shaker for 12 hours to 18 hours. Cells were harvested by centrifugation at 3000×g for 10 minutes, washed two times in 0.9% saline and suspended in a minimal medium (1.0 grams of D-glucose, 7.0 grams of K₂HPO₄, 2.0 grams of KH₂PO₄, 0.5 grams of sodium citrate, 1.0 grams of (NH₄)₂SO₄, and 0.1 grams MgSO₄ in 1 liter distilled H₂O, pH=7.2) to a concentration of about approximately 2×10⁸ cells per ml (Optical density 0.10 at 600 nm).

The minimal broth cultures were incubated for 1 hour at 37° C. with shaking. One to 3 μCi/ml of L-[3,4,5-³H] leucine (obtained from NEN Research Products, Du Pont Company, Wilmington, Del.) were added to the cells and the cell suspensions were incubated for another 20 minutes. These cells were washed 4 times in 0.9% saline and suspended in phosphate buffered saline (PBS) to a concentration of about approximately 10⁸ cells per ml (Optical density 0.10 at 600 nm).

The extended-wear contact lens samples were incubated with 3 ml of the radiolabeled cell suspension at 37° C. for 2 hours. These lenses were removed from the cell suspension with a sterile forceps and immersed 5 times in each of three successive changes (180 ml) of initially sterile 0.9% saline. The lenses were shaken free from saline and transferred to 20 ml glass scintillation vials. Ten ml Opti-Fluor scintillation cocktail (Packard Instrument Co., Downers Grove, Ill.) were added to each vial. The vials were vortexed and then placed in a liquid scintillation counter (LS-7500, Beckman Instruments, Inc., Fullerton, Calif.).

Data for two experiments were converted from disintegrations per minute (dpm) to colony-forming units (cfu) based on a standard calibration curve and expressed as cfU/mm². Calibration curves were constructed from numbers of colonies recovered in pour plates of serial dilutions of inocula and from optical densities (O.D.s) of serial dilutions of cell suspensions of known densities.

Uninoculated extended-wear contact lens samples, which served as controls for the nonspecific uptake of leucine, were treated in the same manner as the inoculated sections. Results are shown below in Table 1.

TABLE 1

| Treat- | Mol. | % | | | | |
|---|---|---|---|---|---|---|
| ment | Wt | E.O | HLB | 1% soln | 3% soln | 5% soln |
| PBS | 0 | 0 | | 1.68E+05 | | |
| control | | | | | | |
| F38 | 4.7 | 80 | 31 | 9.94E+04 | 5.69E+04 | 7.27E+04 |
| P123 | 5.75 | 30 | 8 | 4.91E+02 | 2.83E+02 | 1.96E+02 |
| P105 | 6.5 | 50 | 15 | 4.02E+02 | 2.06E+02 | 0 |
| F77 | 6.6 | 70 | 25 | 1.17E+05 | 2.39E+04 | 3.49E+04 |
| T904 | 6.7 | 40 | 15 | 8.71E+03 | 6.07E+03 | 3.88E+03 |
| F87 | 7.7 | 70 | 24 | 9.61E+04 | 1.69E+05 | 7.88E+04 |
| PEG | 10 | 100 | | 2.73E+04 | 2.83E+04 | 2.91E+04 |
| 10K | | | | | | |
| F127 | 12.6 | 70 | 22 | 1.13E+03 | 1.09E+03 | 1.13E+03 |
| F108 | 14.6 | 80 | 27 | 5.02E+04 | 3.44E+04 | 7.03E+03 |
| T1107 | 15 | 70 | 24 | 2.02E+04 | 1.47E+04 | 9.38E+03 |
| T1307 | 18 | 70 | 24 | 1.12E+04 | 4.36E+03 | 2.27E+03 |
| T908 | 25 | 80 | 31 | 3.28E+04 | 2.23E+04 | 2.44E+04 |
| PEO | 100 | 100 | | 2.34E+04 | 1.90E+04 | 2.89E+04 |
| 7000 | | | | | | |

% EO = Percentage of Ethylene Oxide
HLB = Hydrophilic/Lipophilic Balance

Generally, the data shows that contact lenses treated with polyethers having a higher percentage of ethylene oxide content, and/or higher HLB coefficient, resulted in lower levels of bacterial attachment to the contact lens. Generally, contact lenses treated with higher molecular weight polyethers resulted in lower levels of bacterial attachment, although the effect was more subtle than ethylene oxide content or HLB coefficient. Generally, variations in the polyether concentration of the treatment solution (1 wt %, 3 wt %, 5 wt %) had a relatively small effect on the results. In summary, polyethers having higher ethylene oxide content and/or higher HLB coefficient appear to provide lower bacterial attachment, especially for higher molecular weight polyethers.

### Example 2

Contact lens samples were treated in a manner similar to Example. In this Example, the treatment solutions were reverse poloxamers, as listed in Table 2.

TABLE 2

| | LOG REDUCTION | | | |
|---|---|---|---|---|
| Treatment | 1% | 3% | 5% | 10% |
| 17 R 4 | 1.59E5 + 1.36E4 | 1.64E5 + 1.22E4 | 1.47E5 + 2.43E4 | 1.94E5 + 1.52E4 |
| 17 R 2 | 1.41E5 + 2.16E4 | 1.28E5 + 2.08E4 | 1.32E5 + 2.85E4 | 1.44E5 + 1.30E4 |
| 10 R 5 | 1.91E5 + 2.00E4 | 1.70E5 + 2.67E4 | 1.89E5 + 3.43E4 | 1.47E5 + 3.10E4 |
| PBS Control | 1.94E5 + 5.33E4 | | | |
| 25 R 2 | 2.23E4 + 3.45E3 | 1.76E4 + 3.64E3 | 1.85E4 + 3.94E3 | 3.32E4 + 1.39E4 |
| 25 R 4 | 2.15E4 + 3.87E3 | 2.24E4 + 2.91E3 | 2.04E4 + 3.20E3 | 1.83E4 + 2.41E3 |
| PBS Control | 2.25E4 + 5.04E3 | | | |

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for inhibiting adhesion of bacteria to a surface of a biomedical device comprising contacting the surface of the biomedical device with an aqueous solution comprising a polyether.

2. The method according to claim 1, wherein contacting the surface of the biomedical device with the polyether in an aqueous solution results in formation of a surface coating on the biomedical device.

3. The method according to claim 1, wherein the biomedical device is an ophthalmic lens.

4. The method according to claim 3, wherein the ophthalmic lens is a contact lens.

5. The method according to claim 4, wherein the contact lens is formed from a silicone hydrogel material.

6. The method according to claim 1, wherein the aqueous solution has an ionic strength of from about 200 mOsom/kg to about 400 mOsom/kg.

7. The method according to claim 1, wherein the aqueous solution has an ionic strength of from about 240 mOsom/kg to about 310 mOsom/kg.

8. The method according to claim 1, wherein the aqueous solution is a composition that further comprises one or more components selected from the group consisting of antimicrobial agents, tonicity adjusting agents, buffering agents, chelating agents, pH adjusting agents, and viscosity modifying agents.

9. The method according to claim 1, wherein the aqueous solution further comprises a polymeric quarternary ammonium compounds.

10. The method according to claim 9, wherein the aqueous solution further comprises a cationic polysaccharide.

11. The method according to claim 1, wherein the polyether a poloxamer.

12. The method according to claim 1, wherein the solution is a multi-purpose contact lens solution for cleaning, rinsing, storing and disinfecting a contact lens.

13. The method according to claim 12, wherein the solution further comprises a disinfecting amount of an antimicrobial agent and a buffering agent.

14. The method according to claim 13, wherein the antimicrobial agent comprises a biguanide.

15. The method according to claim 13, wherein the solution further comprises a cationic cellulose polymer.

16. A method for inhibiting adhesion of bacteria to a surface of a biomedical device comprising pre-treating the surface of the biomedical device with a chemical agent and composition to provide reactive groups on the surface of the biomedical device; and contacting the reactive group on the surface with a polyether in an aqueous solution.

17. A method for inhibiting adhesion of bacteria to the surface of a contact lens comprising applying to the surface of the contact lens a polyether-containing composition to form a surface coating of the polyether or the polyether composition on the surface of the contact lens.

18. The method according to claim 17, wherein the polyether is formed from block copolymers comprised of ethylene oxide (EO) and propylene oxide (PO) blocks.

19. The method according to claim 18, wherein the polyether is selected from the group consisting of block copolymers of ethylene oxide-propylene oxide-ethylene oxide and propylene oxide-ethylene oxide-propylene oxide.

20. The method according to claim 17, wherein said composition further comprises an antimicrobial agent, and at least one member selected from the group consisting of tonicity adjusting agents, buffering agents, chelating agents, pH adjusting agents, and viscosity modifying agents.
